(19) United States
(12) Patent Application Publication
(10) Pub. No.: US 2006/0171304 A1
(43) Pub. Date: Aug. 3, 2006

(54) WLAN background scanning

(76) Inventors: David R. Hill, Holden, MA (US); Roger Durand, Amherst, NH (US); Floyd J. Backes, Sharon, NH (US)

Correspondence Address: McGUINNESS & MANARAS LLP, 125 NAGOG PARK, ACTON, MA, 01720, US

(21) Appl. No.: 11/102,997

(22) Filed: Apr. 11, 2005

Related U.S. Application Data
(60) Provisional application No. 60/649,799, filed on Feb. 3, 2005.

(51) Int. Cl. H04J 3/14; H04L 12/56

(52) U.S. Cl. 370/228; 370/389

(57) ABSTRACT

A wireless access point is operable to execute background scans of alternate channels by tuning to the alternate channel for short periods of time, thereby generating sub-windows of data. The sub-windows are calculated to have timing and duration that avoid disruption of communications on the active channel. Multiple background scan sub-windows are used to assemble a virtual target window of the alternate channel, e.g., a 100 mSec window, during which any periodic beacon within range might be expected to be received. The data such as beacon information is employed to generate a table ranking the alternate channels in terms of viability for communications.

### CROSS-REFERENCE TO RELATED APPLICATIONS

A claim of priority is made to U.S. Provisional Patent Application Ser. No. 60/649,799, entitled Interference Counter Measures for Wireless LANs, filed Feb. 3, 2005, which is incorporated herein by reference.

### FIELD OF THE INVENTION

This invention is generally related to wireless communications, and more particularly to background scanning of alternate channels in a WLAN.

### BACKGROUND OF THE INVENTION

Wireless local area networks (“WLANs”) were initially developed to support data communications for client devices such as laptop computers. More recently, support for voice and multimedia services have become a focus of WLAN development. Support for voice and multimedia services introduces new technological hurdles. For example, voice and multimedia service users tend to roam more frequently, and voice and multimedia applications may be more sensitive to delay, jitter, and certain types of interference.

### SUMMARY OF THE INVENTION

In accordance with the invention an apparatus for providing wireless access via at least one of a plurality of channels includes at least one demodulation engine operable to receive radio frequency input on one of the channels, and processing logic operable to control the demodulation engine to support communications on an active channel and contemporaneously scan at least one alternate channel, the processing logic being further operable to maintain a record indicative of detection of network device presence on a scanned alternate channel. The record may include a field for identifying a specific source device such as an SSID of the source device, and a field for identifying a signal strength associated with communications from the device. The demodulation engine may be blindly switched to the alternate channel, switched during a Contention Free Period (“CFP”), switched during an interval of time calculated to be safe, or switched during a NAV interval created by broadcasting a Clear To Send (“CTS”) command.

The processing logic is operable to prompt scanning of the alternate channel after expected client queues have emptied following broadcast of a beacon, and at a power level and duration calculated to avoid disruption of communications on the active channel. For example, the processing logic may set broadcast power of the CTS command such that the command is not received by any adjacent access point operating on the active channel. The processing logic may alternatively reduce the duration specified in the CTS command NAV field if an access point operating on the active channel is likely to receive the CTS command.

Advantages associated with the invention include detection of rogue transmitting devices, near real time adaptation of channel selection algorithms without necessity of reset, near real time adaptation of access point standby functions, enhanced location services enabled by utilizing multiple access points to locate a transmitter in three-dimensional space without dedicated hardware, ranking of alternate channels based at least in-part on traffic on all alternate channels, moving clients to a secondary channel without disrupting communications. Another advantage is enhanced detection of and avoidance of RADAR. For example, without the inventive functions an 802.11h access point may significantly delay channel changing to assure that no RADAR is operating on the secondary channel, whereas the present invention can pre-qualify the secondary channel.

### BRIEF DESCRIPTION OF THE FIGURES

FIG. 1 illustrates a wireless access point configured to support background scanning.

FIG. 2 illustrates assembly of a background scan window from multiple short scans which are gathered in a temporally non-continuous manner.

FIG. 3 illustrates a method for background scanning.

### DETAILED DESCRIPTION

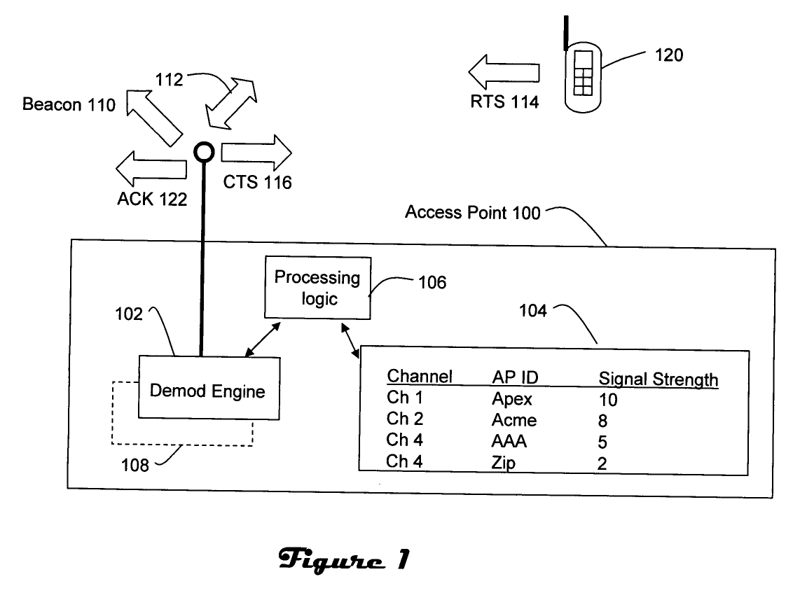

Referring to FIG. 1, an access point (100) configured to support background scanning includes a primary demodulation engine (102), a table (104) of data obtained from background scanning, and processing logic (106) operable to control the demodulation engine in order to generate and maintain the table (104). The access point may also include one or more parallel demodulation engines (108). Each demodulation engine is capable of receiving RF signals on only one channel at a given point in time.

The primary function of the access point (100) is to provide wireless access to client devices (120). Hence, the access point includes functions commonly found in an access point such as periodically broadcasting a beacon (110) indicating the identity of the access point. Further, the access point is operable to associate with one or more client devices in order to move data between the clients and a wired network via a communications link an active channel (112). Communications with clients are typically executed on only one active channel at a time, although the access point could be configured to support multiple active channels. In order to reduce the likelihood of collisions in communications, the client devices may transmit short request to send (“RTS”) packets (114) to the access point, and then begin data transmission only upon receipt of a clear to send (“CTS”) packet (116) transmitted by the access point in response to the RTS, i.e., a CTS that specifically identifies the client device.

The access point (100) also includes a secondary function of background scanning alternate channels. The access point supports a finite number of channels in a predetermined spectrum. Alternate channels are channels which are supported but not presently active. In the illustrated example, which is simplified to facilitate understanding of the invention, the access point supports four channels: Ch1-Ch4. Channel 3 is the active channel (112), and channels 1, 2 and 4 are alternate channels. Scanning of the alternate channels is at least partially subordinate to support of the active channel. In particular, the alternate channels are scanned in a manner which is not significantly disruptive of communications on the active channel.

The primary and secondary functions are executed contemporaneously. In particular, while the demodulation engine may only be capable of communications on a single channel at any given point in time, the supported channel can be switched between the active channel and an alternate channel such that in a given period of time both the support for communications on the active channel and background scanning on the alternative channels are executed. In the case where a parallel demodulation engine (108) is available the parallel engine (108) may execute background scans while the primary demodulation engine (102) executed communications on the active channel.

The result of background scanning is creation and maintenance of the table (104). In the illustrated example each entry in the table includes the channel identity, the identity of access points currently operating on that channel, and the signal strengths at which those access point are transmitting. The identity of the access points may include the SSID broadcast by those access points. The signal strength may indicate the strength of the signal received at the background scanning access point, or the signal strength at which the access point is transmitting if that is readily calculable.

There are multiple techniques for executing the background scan without significantly disrupting proper communications on the active channel (112) while using an access point which employs a single demodulation engine (102) for both communications on the active channel and background scanning of alternate channels. Each technique is operable to quickly re-allocate the demodulation engine to an alternate channel to gather information and then to return to the active service channel before communications are significantly disrupted. One technique is creation of a Contention Free Period (“CFP”), which is an optional MAC functionality. Another technique is use of a CTS command. Another technique is to calculate a point in time and duration for which moving to an alternate channel is unlikely to significantly degrade communications on the active channel. Another technique is to blindly switch to the alternate channel for a short duration.

A CTS command (116) is normally broadcast by an access point to take control of a channel for a specific time duration so that a specific address, and only that address, can transmit. The CTS packet is defined in IEEE 802.11 (7.2.1.2) as a 14 byte packet including a 2 byte frame control field (15:0) which calls out a subtype indicating that it is a CTS frame (001000110100×0×0), a 2 byte duration field that sets a Network Allocation Vector (“NAV”), a 6 byte receiver address field, an access point address field, and a FCS field. A NAV setting of 1024 causes about 1000 microseconds of delay. Broadcasting a CTS causes all RF devices on the WLAN that receive the CTS to set NAV timers to a time duration indicated in the NAV field of the CTS packet. The RF devices do not broadcast for that time duration. Hence, the NAV setting creates a virtual carrier sense of the channel and prevents the other WLAN devices from attempting to transmit on the channel for a particular, selectable period of time. In typical WLAN operation a CTS packet (116) follows a RTS packet (114) which is sent from a client device (120) to the access point (100). The RTS packet can be used by a client device that considers itself a hidden node due to sensed packet errors. IEEE 802.11g (9.6&9.10) provides that a client may send a CTS packet to itself in order to clear the channel immediately before sending an 802.11g OFDM packet when in the presence of legacy 802.11b product. An access point may create a clear window in the active channel by broadcasting a CTS packet addressed to itself or a non-existent address not associated with another device on the WLAN. The duration of the window is determined by the NAV field, which may be set to a value that is relatively unlikely to adversely effect communications on the active channel.

The timing of the background scan is selected to reduce the probability of adversely effecting communications on the active channel. Generally, a period immediately following a beacon (110), when TIM counters elapse, is the most active time for communications because client devices wake up from low power mode to receive traffic that may be buffered for them. Hence, a background scan is executed, or CTS packet in support of a background scan is therefore broadcast, after expected client queues have emptied. A low priority wait period could also be implemented to support background scans. For example, either a SIFS time interval plus 3 slot times or an EIFS period which equates to the bottom 802.11e COS/QOS wait interval could be used before executing the scan or broadcasting the background probe CTS packet so as to reduce present high priority traffic interruptions.

The power level of the broadcast of the CTS packet (116) is selected to reduce the probability of adversely effecting communications on the active channel. All of the WLAN devices that receive the CTS packet set their NAV timer, including other Access Points which may be adjacent on the same channel. If adjacent access points receive the CTS packet they will interrupt their services. Therefore the power level and the rate of the CTS is set, if possible, such that all the client devices receive the CTS, but adjacent access points do not receive the CTS packet. If no such power level exists, priority is given to avoiding reservation of large blocks of time in adjacent access points and networks. For example, the processing logic may be programmed to avoid using background scanning when the access point's RF coverage zone on the channel overlaps another access point, or two access points. Alternatively, the processing logic may be programmed to reduce the duration of the background scan, e.g., to 8 milliseconds, if another access point will observe the CTS packet.

The duration of the background scan is selected to reduce the probability of adversely effecting communications on the active channel. An IEEE 802.11e compliant access point will support multiple codecs. For voice traffic the G.711.a codec supports packet intervals of 10, 20, 30, and 40 milliseconds, and WiFi Alliance WME is presently using 20 milliseconds. Taking codec adaptability into account, the duration of the background scan may be set to the packet interval expanded thru the codec, i.e., the channel should not be interrupted for 41 milliseconds continuously or two packets will drop for G.711.a because the codec can heal itself across one packet drop. The G723.1 codec is used by some meeting applications, e.g., NetMeeting, and is presently the default codec for Microsoft's SIP XP implementation. This codec uses a 30 millisecond packet intervals with a 37.5 millisecond depth (delay). Another codec called out and used by H.323 but not presently supported by WiFi Alliance WME is G.729 which uses a 10 millisecond packet interval and has 15 milliseconds of depth (delay). It will be appreciated that selection of an interval duration acceptable to all supported protocols may be problematic. Consequently, the interval duration may be selected so as to avoid disruption of only those protocols being actively supported. Alternatively, a default background scanning interval duration could be 10 milliseconds, corresponding to a NAV of 10240.

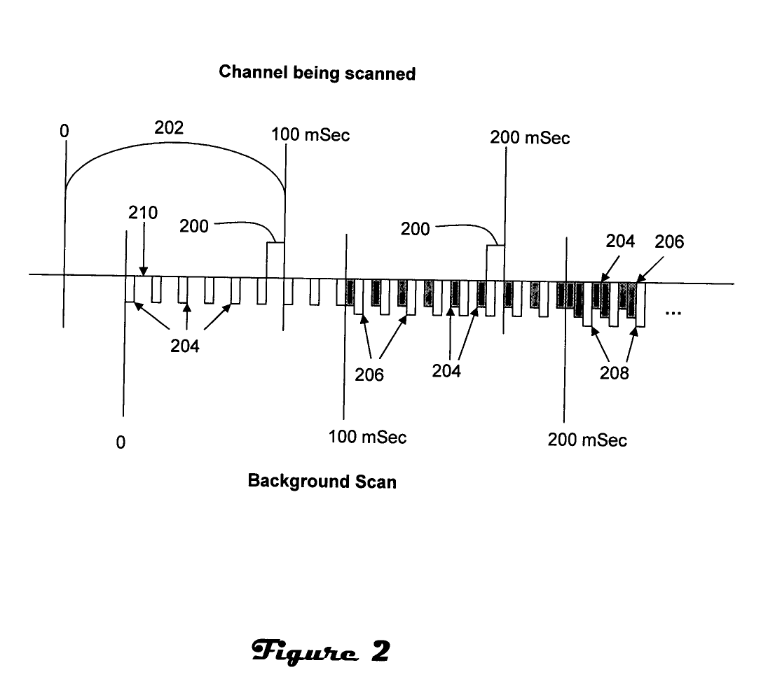

Referring now to FIGS. 1 and 2, access points typically broadcast a beacon every 100 milliseconds. Hence, in order to capture a beacon (200) on an alternate channel, or determine that no beacon is being broadcast on the alternate channel, it is necessary to obtain a 100 millisecond window (202) of background scan data from the alternate channel. However, as discussed above, a single 100 millisecond background scan is likely to disrupt communications on the active channel. A virtual 100 millisecond background scan window is therefore constructed from multiple smaller background scan sub-windows (204, 206, 208) based on the periodicity of the beacon (200). Taking into account the start time of the first background scan sub-window, a periodic series of sub-windows (204) may be employed up to start time plus 100 milliseconds, whereupon the sub-window start times are offset, the duration of the sub-windows are changed, or both. Consequently, sub-windows (206) are implemented in the second 100 mSec window, and sub-windows (208) are implemented in the third 100 mSec window. Sub-windows (204, 206) shown in grey illustrate those portions of the virtual window (target window) already sampled. In this manner an alternate channel may be scanned over the course of multiple 100 mSec windows, depending on the maximum safe size and number of the sub-windows. Those skilled in the art will recognize that the target window (202) may be of any size, and the sub-windows may be implemented in various ways over various periods of time.

The alternate channel may be actively scanned, passively scanned, or both. The determination as to whether or not to actively probe is based in-part on manufacturing 802.11d information burned into the hardware. An active probe will effect all adjacent access points that receive the probe and match the SSID, but will not effect clients, rogues, interference or Radars. An active probe uses priority and can executed very fast, i.e., in <1 millisecond, and can use a EIFS interval to determine surveillance channel finish. A passive probe only has a probability of intercepting beacons, traffic, rogues, interference or Radars and as such will require several passive revisits to a channel for intercept probabilities to reach near 100%. The disadvantage of the passive method is that greater time is required to listen to a channel.

There is some uncertainty in the re-tune setting of the local oscillators when returning to the active channel from a background scan. Therefore, a settling time (210) may be factored into calculations of sub-window size. In the illustrated example the demodulation engine (102) is on the active channel for approximately 20 mSec for every 10 mSec of background scan. A tuning settling interval (210) of up to 40 μsec may be included in the leading edge of the 20 mSec active channel time. After the settling time the access point (100) sends an acknowledge packet (122) to itself with both the more fragments bit set to 0 and the duration bits set to 0. This ack packet with 0 in duration and fragments effectively resets the NAV which restores the channel to proper Distributed Coordination Function (DCF), and for some implementations the random backoff times. Any waiting queues or buffers should now empty. The power of this ack packet should be set the same as the CTS power sent previously.

After the queues empty the processing logic (106) may wait for another EIFS period or SIFS+3 slot times to determine that all traffic is sent, and if no traffic ensues and there is still sufficient time before the next beacon another background scan can be executed. Some sleep client implementations that are concerned about bandwidth will wake up a few milliseconds before the expected beacon and may send data. If the processing logic can determine that all the clients are in sleep mode until the next Beacon/TIM then a background scan may be executed after a wait period.

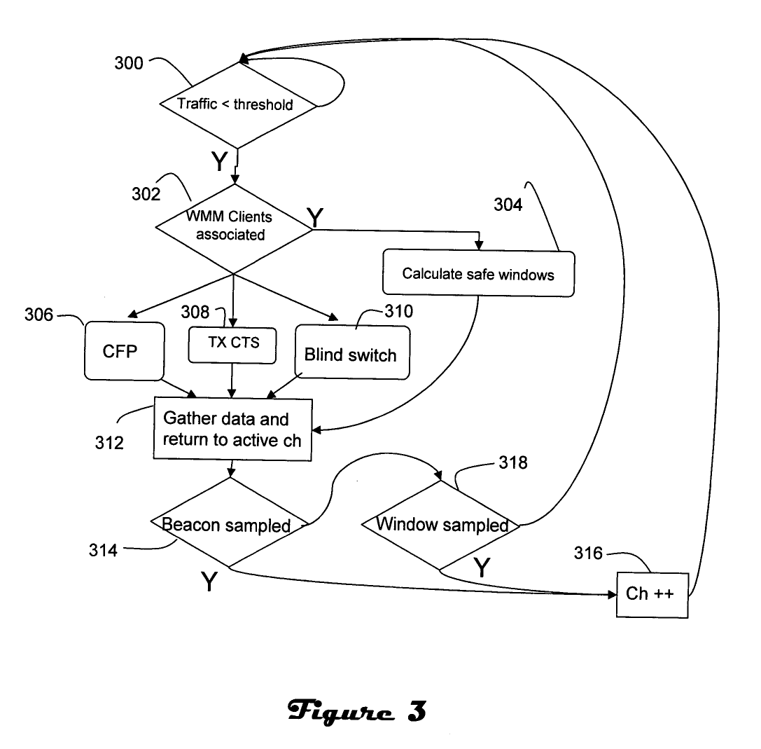

FIG. 3 illustrates a method for performing background scans of alternate channels in a WLAN. In an initial step (300) the traffic on the active channel is compared with a threshold. If the traffic is greater than the threshold then flow loops back. The threshold is selected such that background scanning is disabled during periods of heavy traffic, when the scanning might be disruptive to active traffic. If the traffic is less than the threshold then the processing logic determines whether wireless multimedia (“WMM”) clients are associated with the access point as indicated in step (302). WMM clients are susceptible to interruptions in communications which could be tolerated by some voice and data clients. However, WMM communications are synchronous, or near-synchronous, so it may be possible to calculate safe windows during which background scanning can be executed, as indicated in step (304). If no WMM clients are associated with the access point then one of the techniques already described above is employed to provide sub-windows (204, FIG. 2). In particular, a CFP may be employed as indicated in step (306), a CTS packet may be broadcast as indicated in step (308), or the access point may blindly switch to the alternate channel as indicated in step (310). Whichever technique is employed, the access point then gathers background scan data and returns to the active channel as indicated in step (312).

The processing logic may change the alternate channel being scanned based on whether a beacon is received and whether a full 100 mSec target window is assembled. For example, if a beacon is sampled as indicated by step (314) then the processing logic updates the alternate channel being scanned as indicated in step (306). However, if the beacon is not sampled then a determination is made whether the full target window has been sampled as indicated by step (308). If the target window has been sampled then the channel being scanned is updated, and it is determined that there is no adjacent access point on the channel. If the target window has not been fully sampled then flow loops back to step (300).

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. Apparatus for providing wireless access via at least one of a plurality of channels comprising:
at least one demodulation engine operable to receive radio frequency input on one of the channels; and
processing logic operable to control the demodulation engine to support communications on an active channel and contemporaneously scan at least one alternate channel, the processing logic being further operable to maintain a record indicative of detection of network device presence on a scanned alternate channel.

2. The apparatus of claim 1 wherein the record includes a field for identifying a specific source device.

3. The apparatus of claim 2 wherein the field includes an SSID of the source device.

4. The apparatus of claim 2 wherein the record includes a field for identifying a signal strength associated with communications from the device.

5. The apparatus of claim 1 wherein the processing logic is operable to blindly switch the demodulation engine to the alternate channel.

6. The apparatus of claim 1 wherein the processing logic is operable to employ a Contention Free Period (“CFP”) during which the alternate channel is scanned.

7. The apparatus of claim 1 wherein the processing logic is operable to employ a Clear To Send (“CTS”) command to provide an interval during which the alternate channel is scanned.

8. The apparatus of claim 1 wherein the processing logic is operable to calculate periodic time intervals not used by Wireless MultiMedia clients during which the alternate channel is scanned.

9. The apparatus of claim 1 wherein the processing logic is operable to prompt scanning of the alternate channel after expected client queues have emptied following broadcast of a beacon.

10. The apparatus of claim 7 wherein the processing logic is operable to set broadcast power of the CTS command such that the command is not received by any adjacent access point operating on the active channel.

11. The apparatus of claim 7 wherein the processing logic is operable to reduce duration specified in the CTS command if an access point operating on the active channel is calculated to receive the CTS command.

12. The apparatus of claim 7 wherein the processing logic is operable to reduce duration specified in the CTS command to an interval calculated to be tolerable by each currently active protocol.

13. The apparatus of claim 1 wherein the processing logic is operable to obtain a 100 mSec window of the alternate channel.

14. The apparatus of claim 13 wherein the 100 mSec window is assembled from a plurality of sub-windows gathered over an interval greater than 100 mSec.

15. The apparatus of claim 1 wherein the processing logic is operable to prompt active scan of the alternate channel.

16. The apparatus of claim 1 wherein the processing logic is operable to prompt passive scan of the alternate channel.

17. The apparatus of claim 1 wherein the processing logic is operable to implement a settling time following tuning the demodulation engine from the alternate channel to the active channel during which communications are not executed.

18. The apparatus of claim 17 wherein the processing logic is operable to prompt the demodulation engine to broadcast an acknowledgement signal corresponding to the CTS command following the settling time.

19. The apparatus of claim 7 wherein the processing logic is operable to prompt another scan of the alternate channel between close of the CTS interval and the following beacon if no traffic is anticipated on the active channel.

20. A method for providing wireless access via at least one of a plurality of channels comprising the steps of:
receiving radio frequency input on an active channel; and
contemporaneously scanning at least one alternate channel to maintain a record indicative of detection of network device presence on the scanned alternate channel.

21. The method of claim 20 including the further step of identifying a specific source device.

22. The method of claim 21 including the further step of identifying the SSID of the source device.

23. The method of claim 21 including the further step of identifying a signal strength associated with communications from the device.

24. The method of claim 20 including the further step of blindly switching the demodulation engine to the alternate channel.

25. The method of claim 20 including the further step of scanning the alternate channel during a Contention Free Period (“CFP”).

26. The method of claim 20 including the further step of broadcasting a Clear To Send (“CTS”) command to provide an interval during which the alternate channel is scanned.

27. The method of claim 20 including the further step of calculating periodic time intervals not used by Wireless MultiMedia clients, and scanning the alternate channel during those intervals.

28. The method of claim 20 including the further step of prompting scanning of the alternate channel after expected client queues have emptied following broadcast of a beacon.

29. The method of claim 26 including the further step of adjusting broadcast power of the CTS command such that the command is not received by any adjacent access point operating on the active channel.

30. The method of claim 26 including the further step of adjusting the NAV duration specified in the CTS command if an access point operating on the active channel is calculated to receive the CTS command.

31. The method of claim 26 including the further step of adjusting the NAV duration specified in the CTS command to an interval calculated to be tolerable by each currently active protocol.

32. The method of claim 20 including the further step of obtaining a 100 mSec target window of the alternate channel before scanning a different alternate channel.

33. The method of claim 32 including the further step of assembling the 100 mSec target window from a plurality of sub-windows gathered over an interval greater than 100 mSec.

34. The method of claim 20 including the further step of actively scanning the alternate channel.

35. The method of claim 20 including the further step of passively scanning the alternate channel.

36. The method of claim 20 including the further step of implementing a settling time following tuning the demodulation engine from the alternate channel to the active channel during which communications are not executed.

37. The method of claim 36 including the further step of broadcasting an acknowledgement signal corresponding to the CTS command following the settling time.

38. The method of claim 26 including the further step of prompting another scan of the alternate channel between close of the CTS interval and the following beacon if no traffic is anticipated on the active channel.
